(19) United States
(12) Patent Application Publication
(10) Pub. No.: US 2013/0275598 A1
(43) Pub. Date: Oct. 17, 2013

(54) Method For Providing Resources In A Cloud, And Associated Apparatus

(71) Applicant: SIEMENS AKTIENGESELLSCHAFT, Munchen (DE)

(72) Inventors: Uwe Hohenstein, Vaterstetten (DE); Michael Jager, Munchen (DE); Anna-Sophie Schwanengel, Munchen (DE)

(73) Assignee: Siemens Aktiengesellschaft, Munchen (DE)

(21) Appl. No.: 13/863,671

(22) Filed: Apr. 16, 2013

(30) Foreign Application Priority Data
Apr. 16, 2012 (DE) 102012206175.4
Jun. 4, 2012 (DE) 10 2012 209 414.8

(51) Int. Cl. H04L 12/24

(52) U.S. Cl. CPC H04L 41/142
USPC 709/226

(57) ABSTRACT

A method for providing resources in a cloud may include retrieving current statistical data in respect of the cloud, identifying stored statistical data in respect of the cloud which has a predefined degree of correspondence with the current statistical data, wherein the stored statistical data additionally includes historical resource requirement codes corresponding to the respective stored statistical data, calculating a future resource requirement of the cloud based at least on the historical resource requirement codes of the identified stored statistical data, and automatically providing resources in the cloud according to the calculated future resource requirement of the cloud via an application interface of the cloud.

### CROSS-REFERENCE TO RELATED APPLICATIONS

This application claims priority to DE Patent Application No. 10 2012 206 175.4 filed Apr. 16, 2012 and DE Patent Application No. 10 2012 209 414.8 filed Jun. 4, 2012. The contents of which are incorporated herein by reference in their entirety.

### TECHNICAL FIELD

The present disclosure relates to a method for providing resources in a cloud and to a corresponding apparatus.

### BACKGROUND

Modern computer applications are increasingly being operated in so-called cloud, the term cloud computing also being used in this connection.

Cloud computing is usually understood as meaning an abstracted IT infrastructure in which the resources (e.g. computing capacity, data storage, network capacities) can be dynamically matched to resource demand. This abstracted IT infrastructure can usually be accessed via a network. To the user, this abstracted IT infrastructure appears e.g. as a remote server which the user cannot specifically define, as if it were hidden in a “cloud”.

An application is operated in a cloud via defined technical interfaces and protocols.

With a cloud, the hardware is not operated or provided by the users themselves. Instead, an abstracted hardware is rented from one or more cloud providers as a service which, for example, can also be located in a geographically distant location. The user's applications or data will then no longer be on the local computer but in the so-called cloud.

The cloud is usually accessed via a network such as the Internet. However, a cloud can also be operated by a company as a so-called private cloud, for example, in which the abstracted IT infrastructure is operated via a corporate network, e.g. an intranet.

In a cloud, the number of resources such as storage or computing power, for example, appears almost unlimited, as these resources can be requested and/or re-requested virtually as and when required. Cloud providers offer corresponding payment models in which often only the requested resources have to be paid for and no up-front investment in hardware or resources needs to be made.

The resources required by a cloud application must normally be ordered or requested from the cloud operator by the application operator in order to respond to changed load situations.

For this purpose today's cloud computing platforms usually offer a possibility of setting the amount of resources required via a resource setting interface on a corresponding portal, e.g. an Internet portal in the form of a website, the requesting of resources being a manual activity and the responsibility of the operator of the respective cloud application.

For example, user requests can be handled initially in a private IT infrastructure and, in the event of overload situations, a connected external cloud computing platform in the local IT infrastructure can be used in which additional virtual machines can be provided, said additional virtual machines being requested manually, as already described above.

Today's systems provide the possibility of monitoring the performance of an application which is executed in a cloud, e.g. using different codes. One possible code can indicate whether problems will occur in the near future, and another code can indicate an existing overload. For example, the first code can be the number of requests in a queue, long request processing times, maximum CPU usage and a low rate of executions per second or the like. The second code can be the number of new applications or processes to be launched.

A method of this kind in which the current performance data and corresponding resource management are analyzed manually is demonstrated e.g. in the publication “Alam, K., Keresteci, E., Nene, B., and Swanson, T. (2011). Documentation. http://cloudninja.codeplex.com/releases/view/65798”.

Providing resources manually on the basis of reservations results in the required resources often being provided too late, and means, for example, that a user will already have been adversely affected. For this reason, more resources than are currently required for an application operated in a cloud are often reserved. Over-reservation enables load peaks to be absorbed, but this also results in an excessively high energy requirement in the cloud. Lastly, this also increases the cost of operating the cloud or rather for operating an application in a cloud.

### SUMMARY

One embodiment provides a method for providing resources in a cloud, comprising the steps: retrieving current statistical data in respect of the cloud; identifying stored statistical data in respect of the cloud which has a predefined degree of correspondence with the current statistical data, wherein the stored statistical data additionally has historical resource requirement codes corresponding to the respective stored statistical data; calculating a future resource requirement of the cloud based at least on the historical resource requirement codes of the identified stored statistical data; and automatically providing resources in the cloud according to the calculated future resource requirement of the cloud via an application interface of the cloud.

In a further embodiment, the method includes determining a current resource requirement of the cloud.

In a further embodiment, the method includes calculating a relationship between the current statistical data and the determined current resource requirement; and updating the stored statistical data on the basis of the calculated relationship of the current statistical data and the current resource requirement.

In a further embodiment, for calculating a relationship the correlation between the current statistical data and the current resource requirement is calculated; and/or for calculating a relationship the time lag between the current statistical data and the current resource requirement is calculated; and/or for calculating a relationship the slope of the current statistical data and the slope of the current resource requirement are calculated and compared.

In a further embodiment, the method further includes calculating the difference between the current resource requirement of the cloud and the calculated future resource requirement of the cloud; and automatically providing additional resources in the cloud at least on the basis of the calculated difference via the application interface of the cloud.

In a further embodiment, for identifying stored statistical data the variance of the stored statistical data and the current statistical data are calculated and compared; and/or for the identification of stored statistical data the slope of the stored statistical data and of the current statistical data are calculated and compared; and/or for the identification of stored statistical data the correlation of the stored statistical data and the current statistical data is calculated.

In a further embodiment, the current statistical data is retrieved from a search engine and/or a messaging service and/or a social network and/or an electronic organizer of at least one user of the cloud; and/or for calculating the future resource requirement at least one resource guarantee and/or a provisioning time of the respective resources and/or resource costs of the respective resources are taken into account.

In a further embodiment, the automatic provision of resources in the cloud includes providing computing power and/or main memory and/or transmission bandwidth.

Another embodiment provides an apparatus for providing resources in a cloud, comprising: a retrieval device which is designed to retrieve current statistical data in respect of the cloud; an identification device which is designed to identify stored statistical data in respect of the cloud which has a predefined degree of correspondence with the current statistical data, wherein the stored statistical data additionally has historical resource requirement codes corresponding to the stored statistical data; a computing device which is designed to calculate a future resource requirement of the cloud based at least on the historical resource requirement codes of the identified stored statistical data; and a provisioning device which is designed to automatically provide resources in the cloud according to the calculated future resource requirement of the cloud via an application interface of the cloud.

In a further embodiment, the apparatus includes an acquisition device which is designed to acquire a current resource requirement of the cloud.

In a further embodiment, the apparatus includes an updating device which is designed to calculate a relationship between the current statistical data and the acquired current resource requirement and to update the stored statistical data on the basis of the calculated relationship of the current statistical data and the current resource requirement.

In a further embodiment, for calculating a relationship the updating device is designed to: calculate the correlation between the current statistical data and the current resource requirement; and/or calculate the time shift between the current statistical data and the current resource requirement; and/or calculate and compare the slope of the current statistical data and the slope of the current resource requirement.

In a further embodiment, the computing device is additionally designed to calculate the difference between the current resource requirement of the cloud and the calculated future resource requirement of the cloud; and wherein the provisioning device is additionally designed to automatically provide further resources in the cloud based at least on the calculated difference via the application interface of the cloud.

In a further embodiment, for identifying stored statistical data the identification device is designed to: calculate and compare the variance of the stored statistical data and the current statistical data; and/or calculate and compare the slope of the stored statistical data and of the current statistical data; and/or calculate the correlation of the stored statistical data and the current statistical data.

In a further embodiment, the apparatus includes a communication device which is designed to retrieve the current statistical data from a search engine and/or a messaging service and/or a social network and/or an electronic organizer of at least one user of the cloud.

In a further embodiment, for calculating a future resource requirement the computing device is designed to take into account at least one resource guarantee and/or a provisioning time of the respective resources and/or resource costs of the respective resources; and/or for automatically providing resources in the cloud the provisioning device is designed to provide computing power and/or main memory and/or transmission bandwidth.

### BRIEF DESCRIPTION OF THE DRAWINGS

Exemplary embodiments will be explained in more detail below based on the schematic drawings, wherein:

FIG. 1 shows a flow chart of an example embodiment of the disclosed method;

FIG. 2 shows a block diagram of an example embodiment of the disclosed apparatus; and

FIG. 3 shows a block diagram of another example embodiment of the disclosed apparatus.

### DETAILED DESCRIPTION

Embodiments of the present disclosure provide a means of operating a cloud in an energy saving manner.

For example, some embodiments provide:
a method for providing resources in a cloud, comprising the following steps: retrieving current statistical data in respect of the cloud, identifying stored statistical data in respect of the cloud which has a predefined degree of correspondence with the current statistical data, wherein the stored statistical data additionally has historical resource requirement codes corresponding to the respective stored statistical data, calculating a future resource requirement of the cloud based at least on the historical resource requirement codes of the identified stored statistical data, automatically providing resources in the cloud according to the calculated future resource requirement of the cloud via an application interface of the cloud.
an apparatus for providing resources in a cloud, comprising a retrieval device which is designed to retrieve statistical data in respect of the cloud, an identification device which is used to identify stored statistical data in respect of the cloud which has a predefined degree of correspondence with the current statistical data, wherein the stored statistical data additionally has historical resource requirement codes corresponding to the respective stored statistical data, a computing device which is designed to calculate a future resource requirement of the cloud based at least on the historical resource requirement codes of the identified stored statistical data, and a provisioning device which is designed to automatically provide resources in the cloud according to the calculated future resource requirement of the cloud via an application interface of the cloud.

One insight underlying certain embodiments is that a cloud's resource requirement can be determined on the basis of statistical data.

Some embodiments thus take this insight into account and provide a means of analyzing current statistical data in respect of a cloud and making an estimate concerning the future resource requirement based on a comparison of the current statistical data with stored statistical data and historical resource requirement codes relating to the stored statistical data.

To this end, the some embodiments provide for identifying stored statistical data having a predefined degree of similarity with the current statistical data.

Other embodiments provide for analyzing historical resource requirement codes stored together with the respective stored statistical data and using it to calculate a future resource requirement of the cloud.

Still other embodiments provide that the corresponding resources are made available automatically in the cloud. This can take place e.g. via a cloud application interface, also known as an API.

Certain embodiments therefore make it possible for a cloud to be operated very efficiently and only the resources that are actually required to be provided, thereby making the operation of the cloud or more specifically of an application in the cloud very energy-efficient. In addition, the costs for an operator of a cloud or an application in the cloud can be reduced.

In one embodiment, it is provided to determine a current resource requirement of the cloud. If the current resource requirement is determined, the cloud can be monitored during operation and it can be ensured that sufficient resources are available in the cloud.

In one embodiment, it is provided to calculate a relationship between the current statistical data and the determined current resource requirement and to update the stored statistical data on the basis of the calculated relationship of the current statistical data and the current resource requirement. This enables the stored statistical data to be continuously updated during operation of the cloud and therefore the quality of the resource requirement prediction to be improved.

In one embodiment, for calculating a relationship, the correlation between the current statistical data and the current resource requirement is calculated.

Additionally or alternatively, for calculating a relationship, the time lag between the current statistical data and the current resource requirement is calculated.

Additionally or alternatively, for calculating a relationship, the slope of the current statistical data and the slope of the current resource requirement are calculated and compared.

These three possible embodiments make it possible to indicate precisely the relationship between the trend of the current statistical data and the trend of the resource requirement. The prediction of the resource requirement of the cloud can therefore be improved still further.

In one embodiment, it is provided to calculate a difference between the current resource requirement of the cloud and the calculated future resource requirement of the cloud and to automatically provide, via the application interface of the cloud, additional resources in the cloud based at least on the calculated difference. This enables resources available in the cloud to be adjusted dynamically if, for any reason, the amount of automatically provided resources does not correspond to the actually required amount of resources.

In one embodiment, for identifying stored statistical data, the variance of the stored statistical data and of the current statistical data are calculated and compared.

Additionally or alternatively, for identifying stored statistical data, the slope of the stored statistical data and of the current statistical data are calculated and compared.

Additionally or alternatively, for identifying stored statistical data, the correlation between the stored statistical data and the current statistical data is calculated.

These embodiments provide a simple means of identifying the stored statistical data which coincides best the current statistical data, thereby enabling the future resource requirement of the cloud to be accurately predicted.

In one embodiment, the current statistical data is retrieved from a search engine and/or a messaging service and/or a social network and/or an electronic organizer of at least one cloud user. This enables statistical data thematically related to the cloud to be acquired and therefore current statistical data to be acquired having a high degree of informative value for the possible trend of the resource requirement of the cloud.

In one embodiment, for calculating a future resource requirement, at least one resource guarantee and/or a provisioning time of the respective resources and/or resource costs of the respective resources and/or additional factors are taken into account. This enables the provision of resources for the cloud to be controlled not only as a function of resource requirement codes. Rather, less clearly defined requirements can also be included in the calculations which enable not only quality assurance of the cloud but also other objectives to be observed.

In one embodiment, the automatic provision of resources in the cloud involves providing computing power and/or main memory and/or transmission bandwidth. This enables the provision of resources to be individually matched to the anticipated load situation.

Where appropriate, the above embodiments and developments can be combined with one another as required. Other possible embodiments, developments and implementations of the invention also include combinations, not explicitly stated, of features of the invention described above or in the following in respect of the exemplary embodiments. In particular, the average person skilled in the art will also add individual aspects as improvements or supplements to the respective basic form of the present invention.

In the context of this disclosure, statistical data is to be understood as data that can characterize information concerning a potential interest of users in the respective application executed in the cloud. Such data can be, for example, the frequency of a search term in a search engine. Such data can also be the frequency with which a term is mentioned in a short message service. Such a short message service can be e.g. a news feed, an ATOM feed, a Twitter-like messaging service or the like. Other sources for the statistical data can be other publically accessible data sources such as e.g. forums, newsgroups, social networks such as e.g. Facebook or Google+, or similar. Statistical data can even be data provided by the users of the application executed in the cloud themselves. For example, users, in particular employees of a company, can enter appointments in an electronically maintained diary. In one embodiment, statistical data can be obtained from these appointments. For example, it can be inferred from an appointment for a videoconference that a videoconferencing application operated in a cloud is required. If e.g. all the appointment diaries of employees of a company are analyzed in respect of videoconferencing dates, a very good estimate of the requirement for videoconferencing capacities can be made. The same applies to teleconferences and the like.

In addition, in the context of this disclosure the degree of correspondence between stored statistical data and current statistical data is to be understood as a correspondence that can be calculated e.g. automatically on the basis of a correlation. To determine the degree of correspondence, it is also possible to use e.g. the slope (in the mathematical sense) of the number of mentions over time of a term or the like.

In addition, in the context of this disclosure the term resource requirement codes is to be understood as codes which characterize the amount of resources required in the cloud when given statistical data is present. Said resource requirement codes also characterize the time relationship between the statistical data and the corresponding resource requirement trends. For example, statistical data can indicate the accumulated occurrence of a search term and the corresponding resource requirement codes can indicate that approximately half an hour after this accumulated occurrence the resource requirement of the cloud has increased by a certain percentage. This relationship can be e.g. due to the fact that, after a certain time, interested users searching a particular term will access a service or a home page offered in the cloud.

Lastly, in the context of this disclosure the term providing resources is to be understood as providing an appropriate amount of resources. This means that providing resources can also mean reducing existing resources. If the calculation of the future resource requirement yields the result that e.g. fewer resources are required in the future than are currently available, the existing resources are reduced accordingly to the calculated future resource requirement by the automatic provision of resources via the application interface of the cloud.

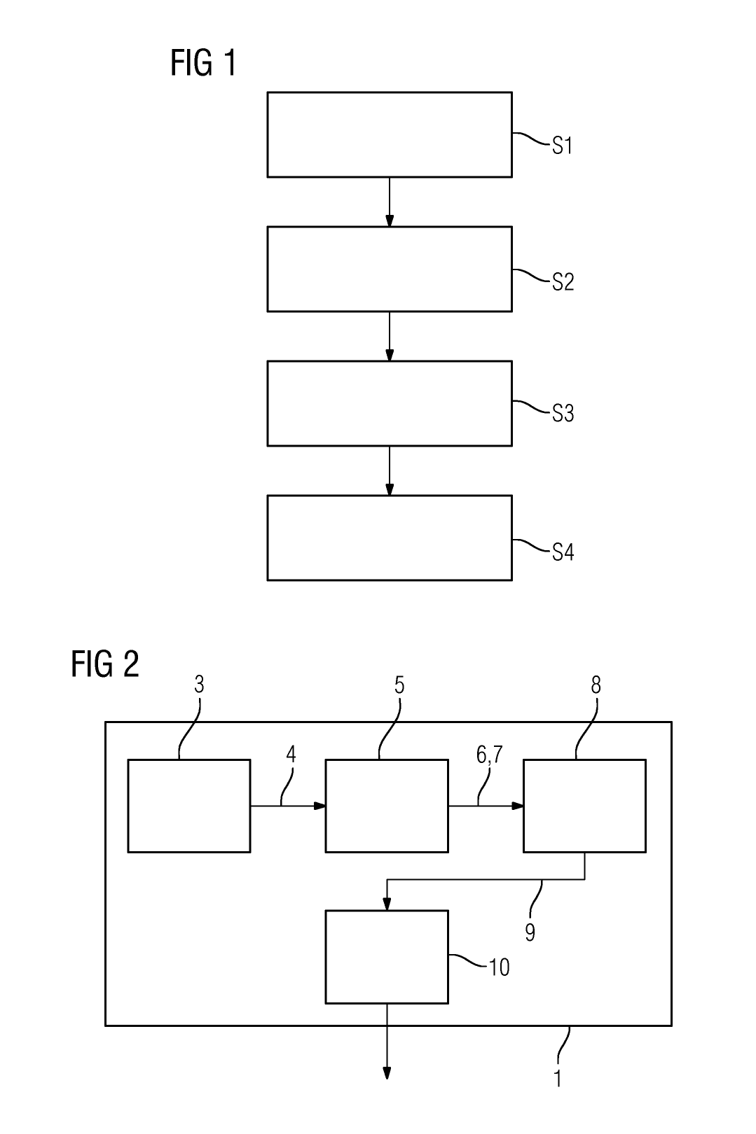

FIG. 1 shows a flow chart of an example embodiment of the disclosed method.

In a first step S1, current statistical data in respect of the cloud 2 is retrieved. This means that current statistical data 4 e.g. concerning the frequency of use of a search term in a search engine is acquired, wherein the search term is a search term that is related to the cloud 2. For example, a search term may be used which contains the name of a company or a department of a company that operates a cloud 2 or provides a service via the cloud 2. Such a search term can be “Siemens Healthcare”, for example.

In a second step S2, stored statistical data 6 in respect of the cloud 2 is identified that has a predefined degree of correspondence with the current statistical data 4. The stored statistical data 6 additionally has historical resource requirement codes 7 corresponding to the respective stored statistical data 6.

For identification S2 of the stored statistical data 6, in one embodiment the variance of the stored statistical data 6 and of the current statistical data 4 can be calculated and compared. If the variance largely coincides, the corresponding stored statistical data 6 can be classified as relevant.

For identification S2 of the stored statistical data 6, in another embodiment the slope of the stored statistical data 6 and of the current statistical data 4 can be calculated and compared. If the slopes largely coincide, the corresponding stored statistical data 6 can be classified as relevant.

For identification S2 of the stored statistical data 6, in another embodiment the correlation of the stored statistical data 6 and the current statistical data 4 can also be calculated. If the correlation largely coincides, the corresponding stored statistical data 6 can be classified as relevant.

After identification S2 of the stored statistical data 6, a future resource requirement of the cloud 2 is calculated at least on the basis of the historical resource requirement codes 7 of the identified stored statistical data 6, it being assumed in the simplest case that the future resource requirement of the cloud 2 will evolve according to the historical resource requirement codes 7. In other embodiments, for calculating the future resource requirement, the degree of correspondence or rather the differences between the stored statistical data 6 and the current statistical data 4 can be used to adjust the historical resource requirement codes 7 accordingly.

For calculation S3 of the future resource requirement 9, in one embodiment other factors can also be included in the calculation.

For example, in one embodiment an agreed resource guarantee (also known as a Service Level Agreement or SLA) can also be included in the calculations. The SLA specifies e.g. which response times or throughput rates or the like are to be guaranteed to a customer or user. If no strict requirements are specified by the SLA, there is no need, for example, to respond immediately to load increases. This reduces e.g. the energy requirement of the cloud 2.

In another embodiment, e.g. the resource costs can also be included in the calculations. For example, in the case of high resource costs, a conservative strategy for the provision of resources 11 can be used. If the costs of the resources 11 are low, resources 11 can also, for example, be over-provisioned in order to allow for unexpected or spontaneous load peaks. This ensures that users are always provided with the necessary or desired performance.

In another embodiment, a provisioning time of the respective resources 11 can also be included in the calculations. If, for example, provisioning takes several minutes, short-notice provisioning may take place too late in the event of a load peak.

In one embodiment, the above mentioned influencing factors can also be combined as required.

If the above mentioned factors are included in the calculations, different strategies can be used for providing resources 11.

An early resource request can be used, for example, in the event of expected and/or periodic load peaks. A no-response is conceivable, for example, if no SLA exists or a long provisioning time would result in an overly late response. Spontaneous resource requests can take place in the case of a fast provisioning time unless the resource costs are prohibitive. Lastly, in the case of a long provisioning time and/or high costs for the resources, a response can be withheld in order to observe how the load situation in the cloud develops. In some cases it is possible to process pent-up loads retrospectively after a one-off resource request. In one embodiment, the resources can also be continuously provided.

Finally, in a fourth step S4, resources 11 are provided in the cloud 2 according to the calculated future resource requirement 9 of the cloud 2 via an application interface 12 of the cloud 2.

This automatic provision S4 of resources 11 includes the automatic provision S4 of computing capacity and/or main memory and/or transmission bandwidth for the cloud or more specifically an application executed in the cloud.

In one embodiment, further steps for adjusting the stored statistical data 4 are carried out, thereby enabling the stored statistical data 4 to be updated and adapted to changed circumstances. For this purpose a current resource requirement of the cloud 2 is determined. In addition, a relationship between the current statistical data 4 and the determined current resource requirement 9 is calculated.

The stored statistical data 6 is then updated on the basis of the calculated relationship between the current statistical data 4 and the current resource requirement 9.

For calculating this relationship, in one embodiment the correlation between the current statistical data 4 and the current resource requirement 9 is calculated.

For calculating this relationship, in another embodiment the time shift between the current statistical data 4 and the current resource requirement 9 is calculated.

For calculating this relationship, in yet another embodiment the slope of the current statistical data 4 and the slope of the current resource requirement 9 are calculated and compared. A combination of the above mentioned possibilities or further possibilities are likewise possible.

A possible embodiment based on the Twitter API will now be described.

In one embodiment, the relevant search terms for a query to the Twitter API are administered in a table. In this table are entered search terms for which the mention frequency in tweets is retrieved by the Twitter API.

The search terms are regularly extracted from the table and the mention frequency of the individual search terms is recorded via the Twitter API over a definable time interval.

This can take place cumulatively or additively. The relevant factor is e.g. the increase or decrease in mentions. The time of measurement and the number of tweets e.g. in respect of the respective search terms for the defined time interval can then be stored in the table, thereby creating so to speak a history of the tweet mentions.

This also allows a database of stored statistical data 4 to be built up if no stored statistical data 4 is yet available.

At the same time the load of the cloud application 2 in the corresponding time interval is recorded and stored. This makes it possible to relate the number of mentions to the load trend. For this purpose the correlation between the tweet mentions and the load trend is obtained for an increase or a reduction in mentions. In addition, the slope of the tweet mentions, the slope of the load trend and the time lag between the slope of the tweet mentions and the slope the load trend can be acquired.

In order to calculate a future resource requirement of the cloud 2, the mention frequency of the search term is acquired for a relevant time interval and its slope in the relevant time interval is calculated. These are then correlated with the stored statistical data 4 for the tweet mentions. This can be done, for example, by calculating the chi-square coefficients.

If a correlation is found between mention frequency of the search term and the stored statistical data 4, the probability of an actual load increase is determined using the resulting chi-square coefficients. For a significant relationship (positive chi-square test), a probability of 80% is assumed and this is scaled up to a probability of 99%.

Together with the determined probability, stored statistical data 4 and the corresponding historical resource requirement codes 7 as well as the calculated probability and the time lag are identified for the relevant time interval. The resources 11 can be provided accordingly in good time.

FIG. 2 shows a block diagram of an example embodiment of the disclosed apparatus 1.

The apparatus 1 for providing resources 11 in a cloud 2 in FIG. 1 has a retrieval device 3 which supplies an identification device 5 with current statistical data 4 in respect of a cloud 2.

The identification device 5 is designed to identify stored statistical data 6 having a predefined degree of correspondence with the current statistical data 4 and to provide it to a computing device 8 together with historical resource requirement codes 7 corresponding to the respective stored statistical data 6.

The computing device 8 is designed to calculate a future resource requirement 9 of the cloud 2 using the historical resource requirement codes 7 and to provide the calculated resource requirement to the provisioning device 10. The provisioning device 10 is designed to automatically provide resources 11 in the cloud 2 in accordance with the calculated future resource requirement 9 of the cloud 2 via an application interface 12 of the cloud 2.

The components of the apparatus 1 can be implemented as program-controlled devices 3, 5, 8 and 10. In addition, the components of the apparatus 1 can be realized in hardware, software, firmware or any combination thereof.

In another embodiment, an acquisition device 13 is provided which is designed to acquire the current resource requirement 9 of the cloud 2.

In another embodiment, an updating device 14 is provided which is designed to calculate a relationship between the current statistical data 4 and the acquired current resource requirement 9 and to update the stored statistical data 6 on the basis of the calculated relationship of the current statistical data 4 and the current resource requirement 9.

The acquisition device 13 and the updating device 14 can be implemented e.g. as program-controlled devices 13 and 14. In addition, the acquisition device 13 and the updating device 14 of the apparatus 1 can be realized in hardware, software, firmware or any combination thereof.

In another embodiment, a communication device 15 is provided for retrieving the current statistical data 4. The communication device 15 can be implemented e.g. as a network interface 15, e.g. an Ethernet interface 15, a WiFi interface 15, or other data interface 15.

In one embodiment, the apparatus 1 is implemented as a computer program product or program module and/or program component running on a computer, e.g. a server, which is operated using an operating system such as e.g. Linux or Windows.

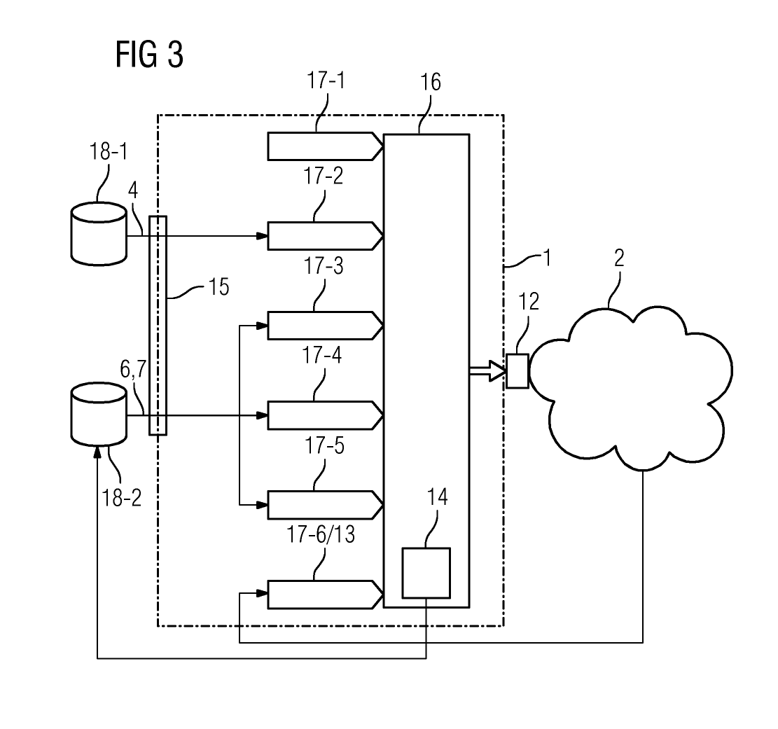

FIG. 3 shows a block diagram of another example embodiment of the disclosed apparatus 1.

The apparatus 1 in FIG. 3 has computer 16 which is designed to execute the functions of the retrieval device 3, the identification device 5, the computing device 8, the provisioning device 10, the acquisition device 13 and the updating device 14.

For this purpose the computer 16 has a plurality of interfaces 17-1-17-6 which are designed to acquire different statistical data. For this purpose the interface 17-2 is linked to a data source 18-1 which is designed to supply the current statistical data 4. In addition, the interfaces 17-3, 17-4 and 17-5 are linked to a data source 18-2 which is designed to provide the stored statistical data 6 and the historical resource requirement codes 7.

Lastly two further interfaces are provided. The interface 17-1 is designed to acquire selectively announced events and the interface 17-6 is linked to the cloud in order to acquire the current resource requirement of the cloud 2.

Although the interfaces 17-3-17-5 are linked to the same data source 18-2, the interfaces 17-3-17-5 are shown separately, as they extract different information from the data source 18-2. The interface 17-3 supplies information concerning the correlation of the current statistical data 4. The interface 17-4 supplies information concerning a variance analysis of the current statistical data 4, and the interface 17-5 supplies a slope analysis of the current statistical data 4. The respective analyses can be carried out by the interfaces, e.g. in the form of program modules, or directly by the data source 18-2.

In addition, the computer 16 is connected to a cloud 2 via an application interface 12. The computer can automatically provide resources in the cloud 2 via this application interface 12 of the cloud.

Although the present invention has been described above with reference to preferred embodiments, it is not limited thereto but can be modified in a variety of ways. In particular, the invention can be changed or modified in diverse ways without departing from the core of the invention.

What is claimed is:

1. A method for providing resources in a cloud, comprising:
retrieving current statistical data regarding the cloud;
identifying stored statistical data regarding the cloud which has a predefined degree of correspondence with the current statistical data, wherein the stored statistical data additionally has historical resource requirement codes corresponding to the respective stored statistical data;
calculating a future resource requirement of the cloud based at least on the historical resource requirement codes of the identified stored statistical data; and
automatically providing resources in the cloud according to the calculated future resource requirement of the cloud via an application interface of the cloud.

2. The method of claim 1, comprising determining a current resource requirement of the cloud.

3. The method of claim 2, comprising:
calculating a relationship between the current statistical data and the determined current resource requirement; and
updating the stored statistical data based on the calculated relationship of the current statistical data and the current resource requirement.

4. The method of claim 3, wherein calculating the relationship includes at least one of:
calculating a correlation between the current statistical data and the current resource requirement;
calculating a time lag between the current statistical data and the current resource requirement; and
calculating and comparing a slope of the current statistical data and a slope of the current resource requirement.

5. The method of claim 2, further comprising:
calculating a difference between the current resource requirement of the cloud and the calculated future resource requirement of the cloud; and
automatically providing additional resources in the cloud based at least on the calculated difference via the application interface of the cloud.

6. The method of claim 1, wherein identifying stored statistical data comprises at least one of:
calculating and comparing a variance of the stored statistical data and the current statistical data;
calculating and comparing a slope of the stored statistical data and a slope of the current statistical data; and
calculating a correlation of the stored statistical data and the current statistical data.

7. The method of claim 1, comprising at least one of:
retrieving the current statistical data from at least one of a search engine, a messaging service, a social network, and an electronic organizer of at least one user of the cloud; and
calculating the future resource requirement based on at least one of: at least one resource guarantee, a provisioning time of the respective resources, and resource costs of the respective resources.

8. The method of claim 1, wherein automatically providing resources in the cloud includes providing at least one of computing power, main memory, and transmission bandwidth.

9. An apparatus for providing resources in a cloud, comprising:
a retrieval device configured to retrieve current statistical data regarding the cloud;
an identification device configured to identify stored statistical data regarding the cloud which has a predefined degree of correspondence with the current statistical data, wherein the stored statistical data additionally has historical resource requirement codes corresponding to the stored statistical data;
a computing device configured to calculate a future resource requirement of the cloud based at least on the historical resource requirement codes of the identified stored statistical data; and
a provisioning device configured to automatically provide resources in the cloud according to the calculated future resource requirement of the cloud via an application interface of the cloud.

10. The apparatus of claim 9, comprising an acquisition device configured to acquire a current resource requirement of the cloud.

11. The apparatus of claim 10, comprising an updating device configured to:
calculate a relationship between the current statistical data and the acquired current resource requirement,
update the stored statistical data based on the calculated relationship of the current statistical data and the current resource requirement.

12. The apparatus of claim 11, wherein for calculating the relationship the updating device is configured to perform at least one of the following steps:
calculate a correlation between the current statistical data and the current resource requirement;
calculate a time shift between the current statistical data and the current resource requirement; and
calculate and compare a slope of the current statistical data and a slope of the current resource requirement.

13. The apparatus of claim 10,
wherein the computing device is further configured to calculate a difference between the current resource requirement of the cloud and the calculated future resource requirement of the cloud; and
wherein the provisioning device is further configured to automatically provide further resources in the cloud based at least on the calculated difference via the application interface of the cloud.

14. The apparatus of claim 9, wherein for identifying stored statistical data the identification device is configured to perform at least one of the following steps:
calculate and compare a variance of the stored statistical data and a variance of the current statistical data;
calculate and compare a slope of the stored statistical data and a slope of the current statistical data; and
calculate a correlation of the stored statistical data and the current statistical data.

15. The apparatus of claim 9, comprising a communication device configured to retrieve the current statistical data from at least one of a search engine, a messaging service, a social network, and an electronic organizer of at least one user of the cloud.

16. The apparatus of claim 9, wherein for calculating a future resource requirement the computing device is configured to take into account at least one of: at least one resource guarantee, a provisioning time of the respective resources, and resource costs of the respective resources.

17. The apparatus of claim 9, wherein for automatically providing resources in the cloud the provisioning device is configured to provide at least one of computing power, main memory, and transmission bandwidth.
